(19) United States
(12) Patent Application Publication
(10) Pub. No.: US 2017/0034319 A1
(43) Pub. Date: Feb. 2, 2017

(54) SMARTPHONE ACCESSORY WITH CAMERA MODULE

(71) Applicant: Ieon C. Chenn, Laguna Hills, CA (US)

(72) Inventor: Ieon C. Chenn, Laguna Hills, CA (US)

(21) Appl. No.: 14/810,704

(22) Filed: Jul. 28, 2015

(51) Int. Cl. H04M 1/02; H04N 1/00; H04N 5/247; H04N 5/225; H04N 5/232

(52) U.S. Cl. CPC H04M 1/0264; H04N 5/2252; H04N 5/23203; H04N 5/23293; H04N 5/247; H04N 1/00103; H04N 5/2257; H04N 2201/0084

(57) ABSTRACT

An axillary recording module is provided for mounting engagement to a cellphone. The recording module comprises a housing defining a forward cellphone receiving well and a rear camera module compartment. A camera module is disposed within the camera module compartment and extendable upwardly therefrom. The camera module being communicable with the cellphone to facilitate viewing images captured by the camera module on the cellphone.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a smartphone camera accessory, and more particularly, to an axillary recording module adapted to interface with a smartphone to facilitate capturing images from vantage point that cannot be reached by using a smartphone by itself.

For many years now conventional cellphones and smartphones have incorporated camera modules that allow the smartphone to take and display images. Such camera equipped cellphones may be used to take images of a variety of different scenes, but require that the cellphone/camera module be within the reach of the user, in order to properly aim and “click” the image.

More recently it has become popular to use cellphones to take self-images or “selfies” which may then be uploaded to various social media sites to show some activity that the user is engaged in. While the camera may be held at arm's length to provide a wider view of the selfie, the user again is constrained arm's length to be able to expand the field of view. Moreover, the ability to accurately frame and construct the image scene is limited by the fact that the image previewed on the cellphone is an arm's length away, which may make focusing and framing more uncertain.

Some devices have been proposed which will allow selfies to be taken from greater distance. Once such device includes an arm which extends to a cellphone receiving bracket, to which the cellphone may be secured. Wiring from the cellphone to the other end of the arm allows the user to click pictures on the cellphone, while the cellphone is extended beyond the arm's length of the user. While this allows for wider self-portrait images, and facilitates images from positions more spaced from the user, it remains subject to limitations respecting the ability of the user to readily aim and preview the images to be taken, as the preview images is similarly spaced from the user, and therefore more difficult to see.

In order to address these limitations on conventional devices and techniques for taking selfies, it desirable to provide a device and technique for taking selfies wherein the camera module may be spaced from the user, beyond arm's length, but still allow the user to easily see the image being captured, in order to better assure that the image satisfies the needs and wants of the user. It is also preferable if such a device has the ability to take images in a variety of directions, for use in other applications, such as taking images from above a crowd of people.

It is further desirable if such a device would allow for wireless communication between a remote camera module and a local cellphone display that may be used by the user to “click” and control the camera module.

These and other objects and advantages may be implemented through the present invention, in the various embodiments described and illustrated below.

### BRIEF SUMMARY

An axillary recording module is provided for mounting engagement to a cellphone. The recording module comprises a housing defining a forward cellphone receiving well and a rear camera module compartment. A camera module is disposed within the camera module compartment and extendable upwardly therefrom. The camera module is communicable with the cellphone to facilitate viewing of the images captured by the camera module on the cellphone.

In one embodiment the camera module the camera module includes a local wireless communication circuit for wireless communication of images captured by the camera module directly to the cellphone. In another embodiment the local wireless communication circuit is disposed with the camera module compartment, in wired communication with the camera module, for wireless communication of images and control signals between the camera module compartment and the cellphone.

In another embodiment, a camera module output port is provided, in communication with the camera module, for outputting images captured by the camera module via wired communication.

The axillary recording module may further comprise a cellphone, disposed in the cellphone receiving well, the cellphone being in communication with the camera module for receiving and displaying images captured by the camera module.

As described above, the cellphone may be in wireless communication with the camera module, or connected to the camera module by hardwire extending from the cellphone to a camera module output port.

The camera module compartment may define a camera module void, for receiving and exposing the camera module for taking pictures while the camera module is stored in the camera module compartment.

The camera module is preferably extendable from a first position within the camera module void to a second position elevated from the camera module void. The camera module is operative to capture images when the camera module is disposed within the camera module void, as well as when the camera module is elevated above the camera module void.

The camera module may be connected to a telescopically extendable arm, having a first distal portion pivotally connected to the camera module and the second proximal portion connected to the camera module compartment. The camera module is preferably rotatable about the extendable arm first portion.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front perspective view of one embodiment of a cellphone axillary recording module, in accordance with the present invention;

FIG. 2 is a rear perspective view of the axillary recording module;

FIG. 3 is a front view of the axillary recording module;

FIG. 4 is a rear view of the axillary recording module;

FIG. 5 is a right side view of the axillary recording module;

FIG. 6 is a left side view of the axillary recording module;

FIG. 7 is a bottom view of the axillary recording module;

FIGS. 8A-8C and 9 illustrate different fields of movement of the camera module;

FIG. 10 illustrates an embodiment having wireless communication capability disposed within the camera module compartment, with optional hardwire connection of the axillary recording module to another device;

FIG. 11 is a bottom view of the embodiment shown at FIG. 10;

FIG. 12 is a side section view of the axillary recording module across the plane shown at FIG. 4;

FIG. 13 is a side sectional view of the axillary recording module, along the plane shown at FIG. 10;

FIG. 14 is a circuit diagram illustrating components of an exemplary camera module; and

FIG. 15 illustrates an alternate embodiment wherein the wireless communication capability disposed in the camera module compartment, without optional hardwire connection.

### DETAILED DESCRIPTION

The above description is given by way of example, and not limitation. Given the above disclosure, one skilled in the art could devise variations that are within the scope and spirit of the invention disclosed herein, including the use of components having alternate shapes, sizes, communications capabilities and other features. Further, the various features of the embodiments disclosed herein can be used alone, or in varying combinations with each other and are not intended to be limited to the specific combination described herein. Thus, the scope of the claims is not to be limited by the illustrated embodiments.

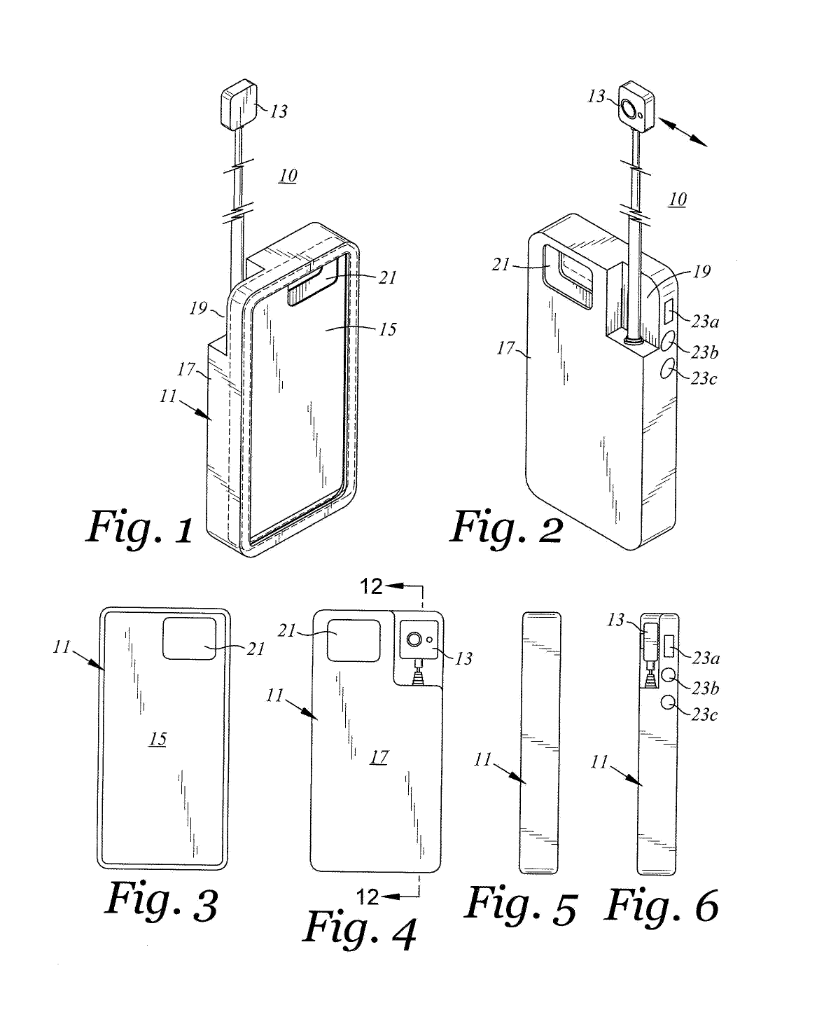

Referring to the drawings, FIGS. 1 and 2 are perspective drawings of one embodiment of a cellphone axillary recording module 10, in accordance with the present invention. In the illustrated embodiment, module 10 includes a housing 11 and a camera module 13 (shown in a deployed or extended position), that is extendable upwardly from the housing 11. More specifically, the housing 11 includes a forward, cellphone receiving well 15 and rear camera module compartment 17. The camera module compartment 17 defines a camera module compartment void 19, into which camera module 13 may be disposed when the camera module is in its stowed/un-deployed position.

FIGS. 3 and 4 show front and rear views of the module 11. As shown at FIGS. 1 and 3, the cellphone receiving well 15 defines an optional aperture 21 which continues through the camera module compartment 17, as shown at FIGS. 2 and 4. The aperture 21 is provided to accommodate a camera mounted on the rear surface of a conventional cellphone. Aperture 21 therefore permits the cellphone to take images, using the cellphone internal camera, instead of the camera module 13. FIGS. 4 and 6 illustrate the orientation of the camera module, within the camera module receiving compartment 17, when the camera module 13 is disposed in its stowed position.

FIGS. 5 and 6 show side views of the axillary recording module 10. Apertures 23a, 23b, and 23c are exemplary of apertures, intended to allow access to the controls, e.g. for power, volume increase and volume decrease, formed on the side of cellphone. Insofar as the arrangement and orientation of controls may vary on different cellphones, it is anticipated that the location, shape, and number of apertures, extending into the cellphone receiving well will also vary, depending upon the particular cellphone that may be used with the axillary recording module.

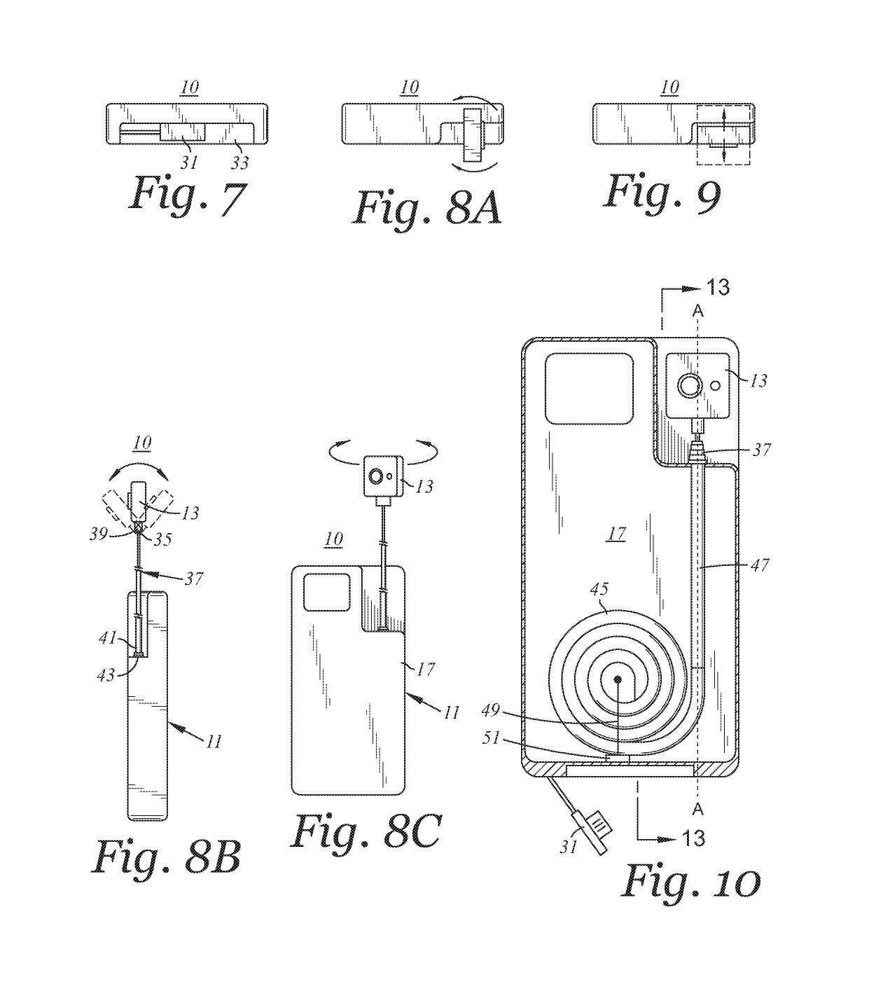

FIG. 7 is a bottom view of the axillary recording module 10, showing a tab 31 engageable to the bottom surface 33, at the bottom of the camera module compartment 17. The tab 31 is wired to wireless communication circuit 65, which in turn is connected to camera module 13, via spool 45 and connector 47. The same connections may be used to charge the camera module 13 from the cellphone. When tab 31 is not used as a hardwired connection to a cellphone, the wireless communication circuit 65 can operate to facilitate wireless communication between the camera module 13 and the cellphone.

FIGS. 8A-8C provide different views showing the adjustability of the camera module 13 to view different areas. As shown at FIG. 8B, the camera module 13 is connected to a first end 35 of extendable arm 37 via a pivotable ball joint 39. Second end 41 of extendable arm 37 is connected to surface 43 of module 10. The extendable arm 37 is telescopically extendable from its stowed position (as shown at FIGS. 10, 12, and 13) to the deployed position, as shown best at FIGS. 1 and 2.

Referring again to FIGS. 8B and 8C, ball joint 39 allows the camera module to swivel about, or rotate around the joint 39 to vary the direction and angle of the field of view of camera module 13. FIG. 9 shows the top view of camera module 10 in different orientations.

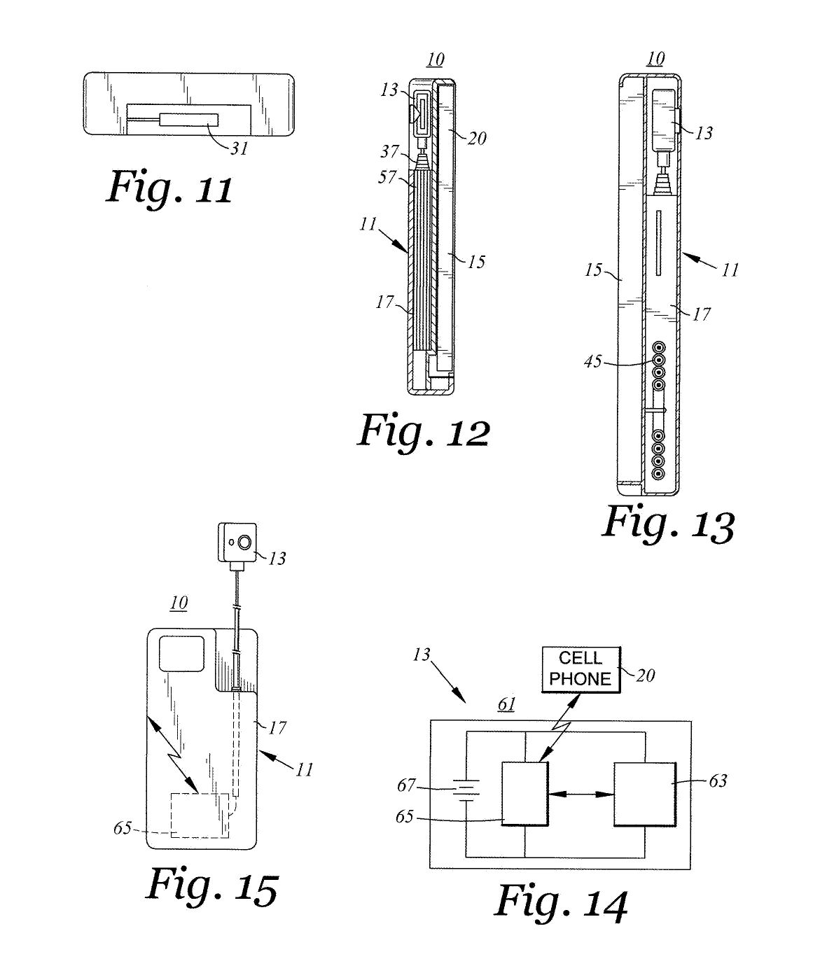

FIG. 10 illustrates one embodiment of the camera module wherein the camera module is hardwired to a wire spool 45 via connector cable 47. In accordance with the embodiment shown at FIG. 10, as the camera module 13 is elevated from its stowed position to a partially deployed or fully deployed position the spool 45 is unwound and deploys upwardly as the camera module 13 is elevated. The spool 45 terminates in a conductor 49 which is engaged to wireless communication circuit 65. Tab 31, connected to wireless communication circuit 65, may be used to connect the camera module to a cellphone input. When a cable is not used, the output port 51 may be covered by tab 31 as shown at FIG. 11. Additional aperture(s) may be provided to facilitate connection of a charging cable to a cellphone when the cellphone is disposed within the cellphone receiving well 15.

FIG. 12 illustrates exemplary cellphone 12 disposed with the cellphone receiving well 15. FIG. 12 also provides further illustration of the telescoping segments of the extendable arm 37, which may be disposed within housing 57, disposed in the cellphone module compartment 17. The telescoping sections are extendable from compartment 57 as the camera module 13 is extended from the cellphone compartment 17.

FIGS. 2, 14, and 15 illustrate wireless communication features that may be implemented within the present invention. FIG. 2 generally illustrates the wireless communication capability of the camera module 13 (e.g. Bluetooth™ or WiFi) to communicate with a cellphone disposed in the cellphone receiving well, or otherwise in the general vicinity of module 10.

FIG. 14 illustrates an exemplary camera module circuit diagram. As shown at FIG. 14, camera module 61 includes an optical image recorder or camera 63, local wireless communication circuit 65 and power supply 67. Wireless communication circuit 65 facilitates wireless communication between the camera module and the cellphone 20, which allows the cellphone to receive and display live images from the camera 63, and to command the camera 63 to click a selected image. The cellphone may further be operative to further regulate the operation of camera 63, e.g. by activating the zoom features, swivel/rotation commands, or other commands that may be executed by the camera 63.

FIG. 15 illustrates an embodiment where the camera module 13 does not include a local wireless communication circuit, which may, under such circumstances, be disposed with the camera module compartment 17.

As it will be apparent to those skilled in the art the particular arrangement of features in the present invention, including the position of the various elements, the means for connecting and communicating between those elements and the applications that may be implemented using those elements may be varied to accommodate different components having different sizes, shapes, and capabilities, without departing from the broader spirit and scope of the claimed invention, which is not be limited by the illustrated embodiments.

1. An auxiliary recording module for mounting engagement to a cellphone comprising:
a) a housing defining a forward cellphone receiving well for receiving and supporting a cellphone and a rear camera module compartment;
b) a camera module disposed within the camera module compartment, the camera module being communicable with the cellphone to facilitate viewing images captured by the camera module on the cellphone; and
c) a telescopically extendable rod having a first end connected to the camera module and a second end connected to the camera module compartment, wherein the rod is extendable to move the camera module from a first proximal position within the camera module compartment, to a second distal position spaced from the camera module compartment.

2. The auxiliary recording module as recited in claim 1 wherein the camera module includes a local wireless communication circuit, for local wireless communication of images captured by the camera module.

3. The auxiliary recording module as recited in claim 1 wherein the camera module compartment defines a camera module output port, in communication with the camera module, for outputting images captured by the camera module.

4. The auxiliary recording module as recited in claim 1 wherein the camera module comprises an image capturing circuit and a wireless communication circuit for wireless communications of images captured by the camera module.

5. The auxiliary recording module as recited in claim 1 further comprising a cellphone disposed in the cellphone receiving well, the cellphone being in communication with the camera module for receiving and displaying image captured by the camera module.

6. The auxiliary recording module as recited in claim 5 further including a local wireless communication circuit disposed within the camera module compartment, and in communication with the camera module, for local wireless communication of images and control signs between the camera module compartment and the cellphone.

7. The auxiliary recording module as recited in claim 5 wherein the camera module compartment defines a camera module output port, in communication with the camera module, for outputting images captures by the camera module to the cellphone.

8. The auxiliary recording module as recited in claim 1 wherein the camera module is controllable in response to commands entered on the cellphone.

9. The auxiliary recording module as recited in claim 8 wherein the camera module compartment defines a camera module void for receiving and exposing the camera module.

10. (canceled)

11. (canceled)

12. The auxiliary recording module as recited in claim 1 wherein the camera module is operative to capture images when the camera module is in the first position and when the camera module is in the second position.

13. The auxiliary recording module as recited in claim 1 wherein the camera module, when in the distal position, is positionable by movement of the housing.

14. The auxiliary recording module as recited in claim 1 wherein the camera module is rotatable about the extendable rod first portion.

15. The auxiliary recording module as recited in claim 1 wherein the rod defines a central axis and has sufficient stiffness to support the camera module substantially along the rod central axis as the rod orientation is changed.

16. The auxiliary recording module as recited in claim 15 wherein the rod includes a plurality of telescoping segments between the first and second ends of the rod and wherein each segment is coaxially aligned with the rod central axis.

17. The auxiliary recording module as recited in claim 1 wherein the rod is linearly extendable to move the camera module in a longitudinal direction from the first proximal position within the camera module compartment of the housing, to the second distal position spaced from the camera module compartment.

18. The auxiliary recording module as recited in claim 1 wherein the rod includes a plurality of telescoping segments between the first and second ends of the rod.

19. The auxiliary recording module as recited in claim 18 wherein the plurality of telescoping segments comprises a plurality of telescoping tube members slidingly surrounding one another between the first and second ends of the rod.

20. An auxiliary recording module for mounting engagement to a cellphone comprising:
a housing defining a cellphone receiving well and a camera module compartment, wherein a cellphone is detachably receivable in the cellphone receiving well;
a camera module receivable within the camera module compartment; and
a telescopically extendable and retractable rod having a plurality of telescoping segments of decreasing diameter, the rod including a first portion connected to the camera module and a second portion connected to the camera compartment, wherein the rod is extendable to move the camera module from a first position wherein the camera module is within a camera-module-compartment, to a second position wherein the camera module is spaced apart from the camera module compartment.
